(19) United States
(12) Patent Application Publication
(10) Pub. No.: US 2024/0377523 A1
(43) Pub. Date: Nov. 14, 2024

(54) TARGET DETECTION DEVICE AND METHOD, AND RADAR DEVICE INCLUDING THE SAME

(71) Applicant: HL KLEMOVE CORP., Incheon (KR)

(72) Inventor: Jong Gu KANG, Incheon (KR)

(21) Appl. No.: 18/628,719

(22) Filed: Apr. 6, 2024

(30) Foreign Application Priority Data
May 9, 2023 (KR) 10-2023-0059866

(51) Int. Cl. G01S 13/52; G01S 7/41; G01S 13/931

(52) U.S. Cl. CPC G01S 13/52; G01S 7/414; G01S 13/931

(57) ABSTRACT

The present embodiments relate to a target detection device and method, and a radar device including the same. A target detection device according to an embodiment may determine a candidate area within a specific distance range from a host vehicle, create a kernel function for each of a plurality of range data included in the candidate area, determine an accumulated probability density by accumulating a plurality of kernel functions, and determines a final stationary target based on the accumulated probability density.

### CROSS REFERENCE TO RELATED APPLICATION

This application claims priority from Korean Patent Application No. 10-2023-0059866, filed on May 9, 2023, which is hereby incorporated by reference for all purposes as if fully set forth herein.

### TECHNICAL FIELD

An embodiment of the present disclosure relates to a target detection device and method, and a radar device including the same. More specifically, the embodiments of the present disclosure relate to a device and a method for accurately identifying and detects targets in situations where radar detection performance deteriorates, such as in a steel tunnel.

### BACKGROUND

Recently, there is widely developed and used a driver assistance system (DAS), and it is required to be acquired accurate target information for the DAS.

An automotive radar may refer to various types of radar devices capable of being mounted on vehicles, and may mean a device used to prevent the possibility of accidents due to poor weather conditions or driver's carelessness and to detect objects around a vehicle.

Recently, as interest in safety and driver convenience has increased, there are developed various vehicle safety and convenience technologies using such vehicle radar devices.

For example, there are developed various technologies, such as smart cruise technology or automatic driving technology for detecting a preceding vehicle and automatically following the preceding vehicle, and automatic emergency braking technology.

Automotive radar, which may be widely used in these technologies, may detect surrounding objects using reflected signals that are reflected after transmitting radar signals.

However, in environments with a clutter such as steel tunnels or soundproof walls, there may often occur a case in that a noise signal greater than the target signal is received.

Due to this phenomenon, a vehicle may not be able to detect a front target vehicle, etc., and there is a problem that a front target cannot be detected in advance depending on the vehicle settings.

### SUMMARY

In this background, an object of the embodiments of the present disclosure is to provide a device and a method capable of accurately identifying a front control targets from a clutter signals due to a steel tunnels and so on, by analyzing received signals obtained from a radar device.

Another object of the embodiments of the present disclosure is to provide a device and a method capable of identifying structures which may generate clutter signals and improving target detection performance in sections where the structures are installed.

Another object of the embodiments of the present disclosure is to provide a device and a method capable of precisely distinguishing between a clutter and a front stationary target by using candidate area selection and kernel density estimation for each range data in an environment with a clutter which interferes a target detection, and a radar device including the same.

In accordance with an aspect of the present disclosure, there may be provided a target detection device including a histogram processor configured to generate and update a histogram representing an object detection frequency for each range using radar reception signals in response to a movement of a host vehicle, a candidate area determiner configured to determine a candidate area within a specific distance range based on the histogram, a kernel density estimator configured to create a kernel function for each of a plurality of range data included in the candidate area and determine an accumulated probability density by accumulating a plurality of kernel functions, and a target determiner configured to determine a target range having an accumulated probability density equal to or greater than a threshold probability density, and determine an object included in the target range as a stationary target.

The histogram processor may update the histogram by accumulating or clustering object detection frequencies for stationary objects within a driving path of the host vehicle at a plurality of time points.

In addition, the candidate area determiner may determine an area including at least one range bin in which the object detection frequency is greater than or equal to a threshold frequency as the candidate area.

The target determiner may determine a range with the maximum accumulated probability density among one or more ranges with the accumulated probability density equal to or greater than the threshold probability density as the target range.

In addition, the target determiner may determine an object included in a range having the accumulated probability density lower than the threshold probability density as a clutter.

The target determiner may provide information about the stationary target to a driver assistance system module for following a preceding vehicle included in the host vehicle.

In accordance with another aspect of the present disclosure, there may be provided a target detection method including generating and updating a histogram representing an object detection frequency for each range using radar reception signals in response to a movement of a host vehicle, determining a candidate area within a specific distance range based on the histogram, creating a kernel function for each of a plurality of range data included in the candidate area, and determining an accumulated probability density by accumulating a plurality of kernel functions, and determining a target range having an accumulated probability density equal to or greater than a threshold probability density, and determining an object included in the target range as a stationary target.

In accordance with another aspect of the present disclosure, there may be provided a radar device including an antenna unit including at least one transmission antenna and at least one receiving antenna, a transceiver configured to control to transmit a transmission signal through the antenna unit and receive a reception signal reflected from an object, a signal processor configured to process the transmission signal and the reception signal to acquire target information, and a target detection device configured to determine a candidate area within a specific distance range from a host vehicle, create a kernel function for each of a plurality of range data included in the candidate area, determine an accumulated probability density by accumulating a plurality of kernel functions, and determines a stationary target based on the accumulated probability density.

As will be described below, according to an embodiment of the present disclosure, it is possible to analyze the reception signal acquired from a radar device to accurately identify a front control target in an environment with clutter signals, such as a steel tunnel.

In addition, according to an embodiment of the present disclosure, it is possible to identify structures which may generate clutter signals and improving target detection performance in sections where the structures are installed.

In addition, according to an embodiment of the present disclosure, it is possible to precisely distinguish between a clutter and a front stationary target by using candidate area selection and kernel density estimation for each range data in an environment with a clutter which interferes a target detection.

### BRIEF DESCRIPTION OF THE DRAWINGS

FIG. 1 illustrates an example of a schematic configuration of a radar device according to an embodiment of the present disclosure.

FIG. 2 illustrates a configuration of a target detection device according to an embodiment of the present disclosure.

FIG. 3 illustrates a driving state of a host vehicle in an environment with a clutter and a front stationary target.

FIG. 4 illustrates an example of radar detection data in a driving environment shown as FIG. 3.

FIG. 5 illustrates a configuration of determining a histogram and candidate area for a target detection device according to an embodiment.

FIG. 6 illustrates a configuration of determining a candidate area from radar detection data.

FIGS. 7A and 7B illustrate an example of a kernel function for each range data and an accumulated probability density used in a target detection device according to an embodiment.

FIG. 8 illustrates an example in which clutter and a target are identified in radar detection data according to an embodiment.

FIG. 9 illustrates a principle of obtaining distance-velocity information of an object by a signal processor in a radar device according to the present embodiment.

FIG. 10 is a flowchart of a target detection method according to an embodiment of the present disclosure.

FIG. 11 illustrates a detailed flowchart of a target detection method according to an embodiment.

FIG. 12 illustrates an example of the hardware configuration of the transceiver, signal processor, and target detection device included in a radar device according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described the embodiments in detail with reference to the drawings.

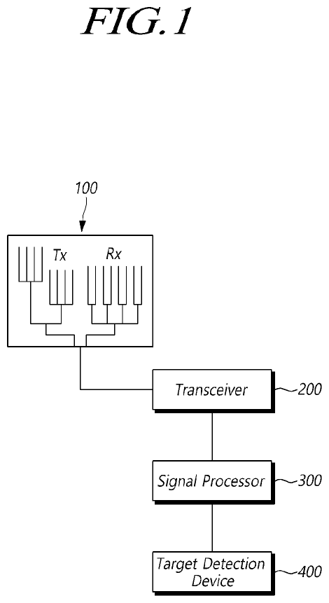

FIG. 1 illustrates an example of a schematic configuration of a radar device according to an embodiment of the present disclosure.

A radar device according to an embodiment of the present disclosure may a multi-input multi-output (MIMO) type radar device including a plurality of transmission antennas.

Hereinafter, it will be described a structure in which the transmission antenna includes a first transmission antenna Tx1 and a second transmission antenna Tx2 as an example, but is not limited thereto.

A radar device according to an embodiment may include an antenna unit 100, a transceiver 200, a signal processor 300, and a target detection device 400.

The antenna unit 100 may include a transmission antenna unit including a first transmission antenna Tx1 and a second transmission antenna Tx2, and a receiving antenna unit including a plurality of receiving antennas.

The transceiver 200 may transmit a transmission signal through the transmission antenna unit and receive a reception signal through the receiving antenna unit.

The transceiver 200 of the radar device according to the present embodiment may include a transmitter and a receiver. The transmitter may include an oscillation part which generates a transmission signal by supplying a signal to each transmission antenna. Such an oscillation part may include, for example, a voltage-controlled oscillator (VCO), an oscillator, and the like.

The receiver included in the transceiver 200 may include a low noise amplifier (LNA) which low-noise-amplifies a reflected signal received through the receiving antenna, a mixer which mixes the low-noise-amplified received signal, an amplifier which amplifies the mixed received signal, and a converter (analog-to-digital converter (ADC)) which digitally converts the amplified received signal to generate reception data.

As described above, the radar device according to the present embodiment may be a MIMO radar device that transmits a plurality of transmission signals simultaneously or in time division and receives the reception signals through a plurality of receiving channels.

In general, radar sensor devices may be classified into a pulse type, a frequency modulation continuous wave (FMCW) type, and a frequency shift keying (FSK) type according to the type of signal used.

The FMCW radar device may utilize an up-chirp signal or a ramp signal, which is a signal whose frequency increases with time, and may calculate information on an object using a time difference between a transmission wave and a reception in wave and a Doppler frequency (fd) shift.

Hereinafter, it will be described an FMCW-type radar device using a fast chirp signal or an up-chirp signal as an example, but is not limited thereto.

The signal processor 300 may determine a beat frequency or Doppler frequency fd from an intermediate frequency signal or a beat signal obtained by mixing (i.e., correlating) a transmission signal and a reception signal.

The Doppler frequency may be proportional to the distance to a target on which the received signal is reflected, and a velocity component or Doppler component of the target may be extracted based on a time change of the Doppler frequency or a phase change.

In addition, the signal processor 300 may generate a virtual channel vector as described below, and estimate an angle (azimuth and/or elevation angle) of the target using the virtual channel vector.

That is, the signal processor 300 according to the present embodiment may obtain target information such as a distance or a range, a speed, and an angle of the target by processing the transmission signal and the reception signal.

The target detection device 400 may be used to identify a clutter and a front target in a situation where there is clutter ahead, which is an obstacle to detecting the front target, such as a steel tunnel.

The target detection device 400 may be implemented within the signal processor 300, but is not limited thereto, and may be implemented as a hardware or software module separate from the signal processor 300.

The target detection device 400 may identify a front target from a clutter using kernel density estimation (KDE).

Specifically, the target detection device 400 may preform functions of 1) determining a candidate area within a specific distance range from a host vehicle, 2) creating a kernel function for each of a plurality of range data included in the candidate area, 3) determining an accumulated probability density by accumulating a plurality of kernel functions, and 4) determining target data based on the accumulated probability density. Here, the range data may be distance data to each object after processing by the signal processor.

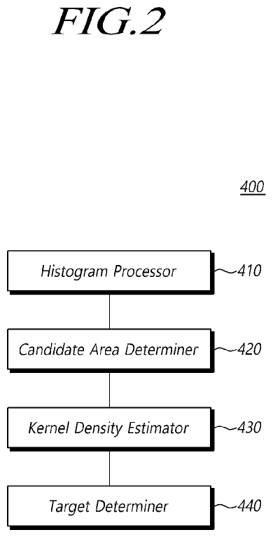

The detailed configuration of the target detection device 400 will be described in more detail below with reference to FIG. 2.

FIG. 2 illustrates a configuration of a target detection device according to an embodiment of the present disclosure.

The target detection device 400 according to an embodiment may include a histogram processor 410, a candidate area determiner 420, a kernel density estimator 430, and a target determiner 440.

The histogram processor 410 may create and update a histogram indicating an object detection frequency for each range using a radar reception signal according to the movement of a host vehicle.

Specifically, the histogram processor 410 may estimate a dynamic histogram indicating the object detection frequency for each longitudinal range (i.e., distance range) based on the radar signal received at a first time point.

Next, the histogram processor 410 may extract a stationary object in a driving path of the host vehicle by analyzing an azimuth and velocity components of the detected object.

In this case, if the azimuth of the detected object is within a specific range based on the azimuth of 0 degrees, which is a traveling direction of the host vehicle, and the host vehicle's driving direction component of the measured relative velocity of the object has the same magnitude as the host vehicle's traveling speed but has an opposite sign, the histogram processor 410 may determine the object to be a stationary object in the driving path of the host vehicle.

Alternatively, the histogram processor 410 may extract a stationary object in the driving path of the host vehicle by analyzing the position and velocity components of the detected object.

For example, if a position of the detected object is located within the driving path of the host vehicle, and the host vehicle's driving direction component of the measured relative speed of the object has the same magnitude and opposite sign as the host vehicle's traveling velocity, the histogram processor 410 may determine the object to be a stationary object in the driving path of the host vehicle.

The histogram processor 410 may determine or update a dynamic histogram to indicate an object detection frequency for each longitudinal range, by targeting only stationary objects included in the driving path of the host vehicle.

In this case, the driving path of the host vehicle may be a path with a specific width determined based on a yaw rate and speed of the host vehicle.

In order to determine a dynamic histogram, the histogram processor 410 may create one dynamic histogram by clustering histograms at a plurality of time points.

That is, the histogram processor 410 may update the histogram by accumulating or clustering the object detection frequencies for stationary objects within the driving path of the host vehicle at a plurality of time points.

As a result, the histogram used to determine the candidate area may represent the number of stationary objects or a detection frequency of stationary objects within the driving path of the host vehicle for each longitudinal range.

The candidate area determiner 420 may determine a candidate area based on one or more created histograms.

That is, the candidate area determiner 420 may determine a range bin in the histogram in which objects are detected above a specific threshold frequency as a candidate area.

Specifically, the candidate area determiner 420 may determine an area including at least one range bin in which the object detection frequency is greater than or equal to the threshold frequency as the candidate area.

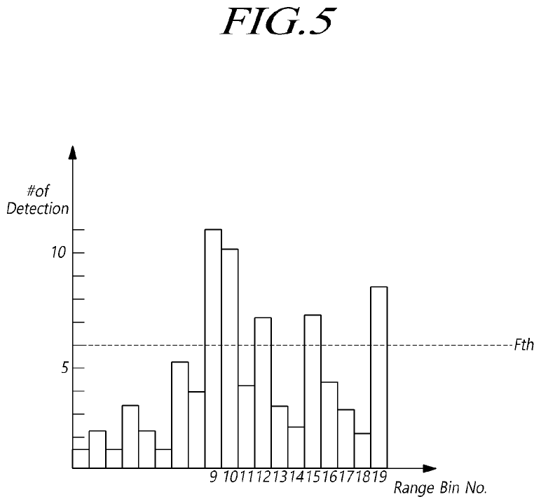

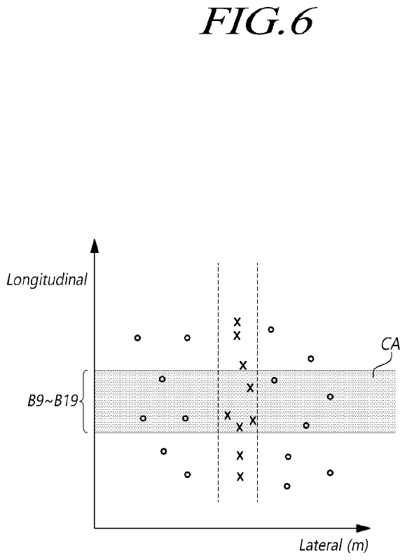

It will be described the determination of the candidate area using the histogram in more detail with reference to FIGS. 5 and 6.

In the specification, range may be used in the same meaning as a longitudinal distance or longitudinal distance range from the host vehicle to an object.

Meanwhile, there may be generated a range-Doppler map by performing two-dimensional Fast Fourier Transformation (FFT) on the radar signal.

The range-Doppler map may include N range sections or range values, and each range section or range value may be expressed as a bin.

In the specification, a candidate area may be defined as an area including an object to which kernel density estimation, which will be described later, will be applied.

The kernel density estimator 430 may create a kernel function for each of a plurality of range data included in the candidate area and determine an accumulated probability density by accumulating the plurality of kernel functions.

Specifically, the kernel density estimator 430 may create a kernel function K for each of one or more range data included in the candidate area.

In addition, the kernel density estimator 430 may determine the accumulated probability density by accumulating kernel functions for one or more generated range data.

The kernel function K may be represented as a normal distribution curve with a constant bandwidth h as a parameter.

More specifically, the kernel function may be a normal distribution curve with a maximum value at 0, and the maximum value of each kernel function may be proportional to the number or detection frequency of stationary objects within each corresponding range.

That is, the greater the number of stationary objects included in the range or the detection frequency, the greater the maximum value of the kernel function may be.

In addition, the smaller the bandwidth h of the kernel function K, the smaller the variance of the kernel function becomes and the sharper the normal distribution curve becomes.

In this case, the bandwidth h of the kernel function K may be a value which minimizes the Mean Integrated Squared Error (MISE), but is not limited thereto.

If a plurality of range data is rᵢ, the accumulated probability density P(r) may be determined by Equation 1 below.

$$P ( r ) = \frac{1}{n} {\sum }_{i = 1}^{n} K ( r - {r}_{i} ) \qquad [ Equation 1 ]$$

Here, r is a random variable, n is the number of ranges included in the candidate area, and rᵢ is a plurality of range data included in the candidate area.

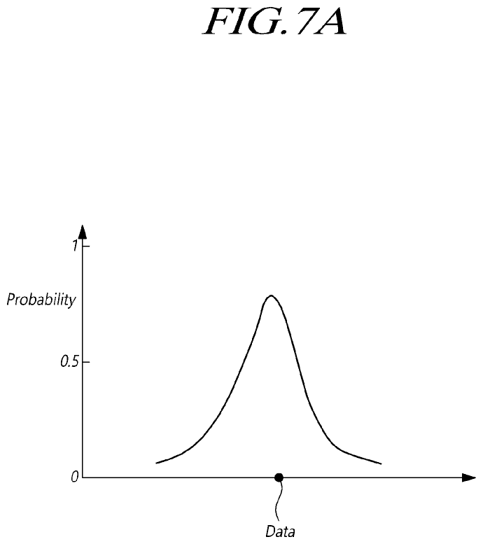

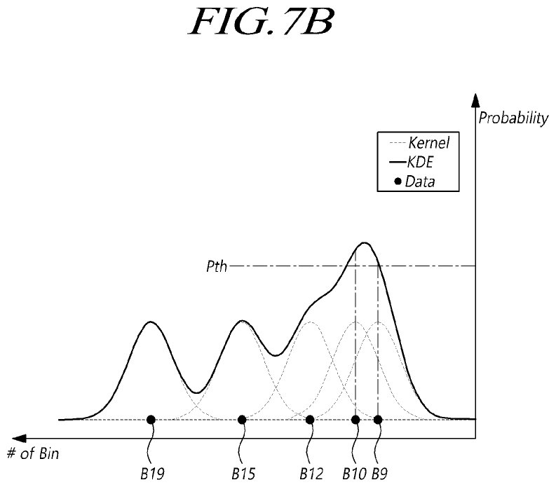

The detailed configuration of the kernel function K for each range and the accumulated probability density P(r) will be described in more detail based on FIG. 7.

The target determiner 440 may determine a range having a accumulated probability density greater than or equal to the threshold probability density among a plurality of ranges included in the candidate area as a target range.

In addition, the target determiner 440 may determine an object included in the target range as a stationary target.

As another example, the target determiner 440 may determine a range with a maximum accumulated probability density among one or more ranges with an accumulated probability density greater than or equal to the predetermined threshold probability density as a target range.

The target determiner 440 may determine an object included in the range having an accumulated probability density less than or equal to the threshold probability density as a clutter, such as a steel tunnel.

In addition, the target determiner 440 may provide information about the stationary target to a driver assistance system (DAS) module for following a preceding vehicle included in the host vehicle.

In this case, the DAS module may be an adaptive cruise control (ACC) module or a smart cruise control (SCC) module.

According to the target detection device and the radar device as described above, in an environment where clutter that interferes with target detection exists, there may precisely distinguish a clutter and a front stationary target by using a candidate area selection and kernel density estimation for each range data.

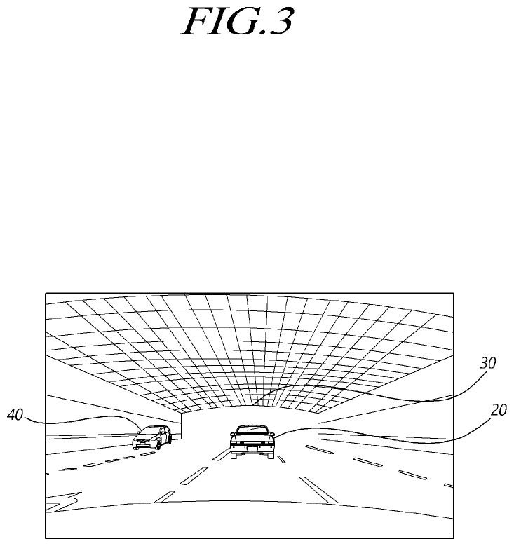

FIG. 3 illustrates a driving state of a host vehicle in an environment with a clutter and a front stationary target.

The target detection device according to an embodiment of the present disclosure may be used, in particular, to identify a stationary target from clutter such as a steel tunnel.

If the host vehicle has an adaptive cruise control (ACC) function or a smart cruise control (SCC) function, there is required to control (i.e., a speed and steering) the host vehicle to follow other preceding vehicles.

For ACC or SCC, there is required to accurately recognize the front target. In this case, a clutter such as a steel tunnel may be a significant obstacle to target detection due to diffuse reflection or scatter of radar signals.

In particular, as a result of radar signal processing, the steel tunnel may be detected as a stationary object. Therefore, if the preceding vehicle to be tracked is stationary, it is difficult to distinguish the steel tunnel from the front target.

Therefore, there may be reduced the reliability of front vehicle tracking control in a harsh environment where a clutter such as a steel tunnel exists.

FIG. 3 illustrates a case that the host vehicle enters a steel tunnel while following the preceding vehicle 20 in front.

In this state, if the preceding vehicle 20, which is the vehicle to be followed, is in a stationary state, the radar signal may be diffusely reflected due to the steel tunnel 30 existing on upper of the host vehicle, and may become impossible to accurately detect the preceding vehicle 20 in front.

Meanwhile, there may be another oncoming vehicle 40 on the left side of the vehicle, and since this other vehicle is a moving target, this other vehicle may be easily distinguished from the steel tunnel 30, which is a stationary target.

As described above, if the preceding vehicle 20, which is a vehicle to be tracked, is stopped within a stationary clutter such as a steel tunnel, there is required to clearly distinguish the front target from the clutter.

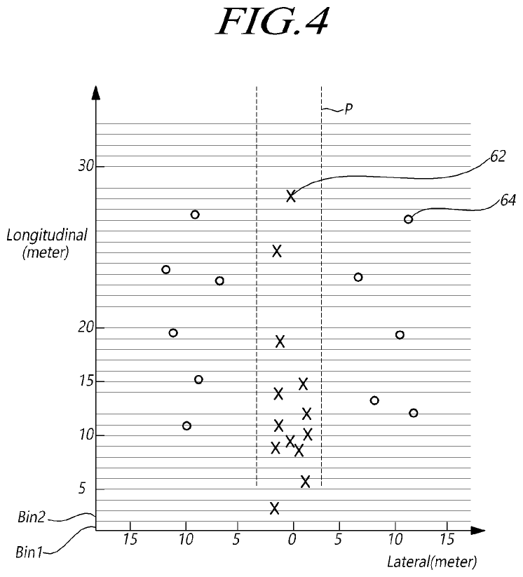

FIG. 4 illustrates an example of radar detection data in a driving environment shown as FIG. 3.

As described above, the signal processor 300 or the target detection device 400 of the radar device may estimate a driving path of a host vehicle using a yaw rate information and vehicle speed information of the host vehicle.

In FIG. 4, the driving path P of the host vehicle is indicated by a dotted line.

In addition, as described above, the signal processor 300 of the radar device may process the transmission signal and the reception signal to acquire information such as the distance or range, relative speed, and angle (i.e., azimuth or elevation angle) of objects around the host vehicle.

The target detection device 400 may determine whether the position of the detected object is within the driving path P of the host vehicle and whether the object is a stationary object, and determine the stationary object within the driving path P of the host vehicle.

Specifically, in the case that the detected object position is located within the driving path P of the host vehicle and the host vehicle's driving direction component of the measured object relative speed is the same in magnitude and opposite sign as the host vehicle's traveling speed, the target detection device 400 may determine the detected object as a stationary object in the driving path of the host vehicle.

The radar detection data in FIG. 4 may represent a space with a lateral distance as the horizontal axis and a longitudinal distance as the vertical axis based on the host vehicle.

In the radar detection data of FIG. 4, the object 62 indicated by ‘x’ may represent a stationary object within the driving path P of the host vehicle, and the object 64 indicated by ‘o’ may represent a stationary object outside the driving path of the host vehicle.

As shown in FIG. 4, the longitudinal distance or range from the host vehicle may be divided into a plurality of bins or a plurality of range bins.

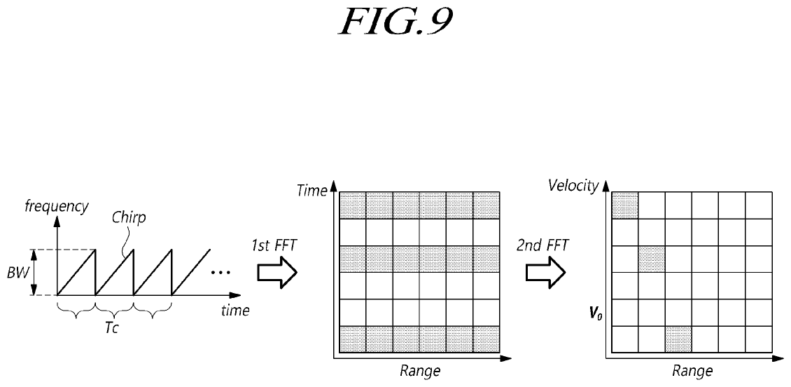

As will be described in FIG. 9, one range bin may correspond to a range resolution capable of being distinguished by performing a two-dimensional FFT on the radar signal.

That is, the range bin closest to the host vehicle may be expressed as Bin1, the next range bin as Bin2, and so on.

FIGS. 5 and 6 illustrate a configuration of determining a histogram and candidate area for a target detection device according to an embodiment.

The histogram processor 410 of the target detection device may create and/or update a histogram as shown in FIG. 5 by accumulating or clustering the object detection frequencies for stationary objects within the driving path of the host vehicle at a plurality of time points.

In the histogram of FIG. 5, there is represented the number of stationary objects cumulatively detected for each range bin.

Specifically, the histogram in FIG. 5 illustrates a case in which one stationary object is detected within the driving path of the host vehicle in the first range bin, and two stationary objects are detected in the second range bin.

In FIGS. 5 and 6, it is assumed that the threshold frequency for determining the candidate area is 6, but it is not limited thereto.

In the 8th range bin, four stationary objects are detected, and in the 9th range bin, eleven stationary objects are detected.

As a result, the histogram used to determine the candidate area may represent the number of stationary objects or detection frequency of stationary objects within the driving path of the host vehicle for each longitudinal range or each range bin.

According to the histogram in FIG. 5, the range bins with a threshold frequency of 6 or more are the 9th, 10th, 12th, 15th, and 19th range bins.

The candidate area determiner 420 may determine the candidate area CA based on the histogram as shown in FIG. 5.

The candidate area determiner 420 may determine a range bin or range bins with a threshold frequency or more as a candidate area.

Specifically, the candidate area determiner 420 may individually determine range bins having the object detection frequency greater than or equal to the threshold frequency Fth as candidate areas.

As another example, the candidate area determiner 420 may determine the entire section between range bins having the object detection frequency greater than or equal to the threshold frequency Fth as the candidate area.

As another example, the candidate area determiner 420 may determine specific range bins surrounding a range bin with the maximum object detection frequency as candidate areas.

In the example of FIG. 5, the candidate area determiner 420 may determine each section of the 9th, 10th, 12th, 15th, and 19th range bins having the object detection frequency greater than or equal to the threshold frequency as a candidate area.

Alternatively, in the example of FIG. 5, the candidate area determiner 420 may determine the entire section of the 9th to 19th range bins, which is the entire section between range bins with having the object detection frequency greater than or equal to the threshold frequency, as the candidate area.

Hereinafter, it will be exemplified a case in which the candidate area determiner 420 determines the entire section between range bins with the object detection frequency greater than or equal to the threshold frequency as a candidate area, but is not limited thereto.

That is, as shown in FIG. 6, the candidate area determiner 420 may determine the entire section of the 9th to 19th range bins as the candidate area CA.

The candidate area CA may include a stationary object (indicated by ‘x’) inside the driving path of the host vehicle and a stationary object (indicated by ‘o’) outside the driving path of the host vehicle.

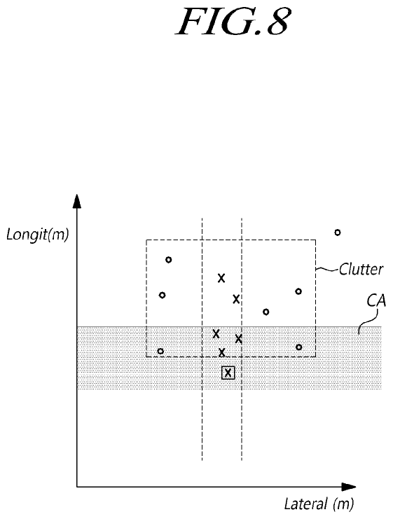

FIG. 7 illustrates an example of a kernel function for each range data and an accumulated probability density used in a target detection device according to an embodiment, and FIG. 8 illustrates an example in which clutter and a target are identified in radar detection data according to an embodiment.

FIG. 7A illustrates a kernel function K for one range data, which is the data of each range bin, among the data of a plurality of range bins included in the candidate area.

As shown in FIG. 7A, the kernel function for each range data may be a normal distribution curve with a maximum value at 0.

In this case, the maximum value of each kernel function may be proportional to the number or detection frequency of stationary objects within each corresponding range, but is not limited thereto.

For example, as shown in FIG. 7, the maximum value of each kernel function may be a constant value regardless of the number of stationary objects in the corresponding range.

The kernel density estimator 430 may determine an accumulated probability density by accumulating kernel functions for one or more generated range data.

FIG. 7B represents an example of the accumulated probability density, and the accumulated probability density may be used in the same meaning as Kernel Density Estimation (KDE).

FIG. 7b may be a graph representing the accumulated probability density determined based on the histograms and candidate areas of FIGS. 5 and 6.

As shown in FIG. 7b, the kernel density estimator 430 may create a kernel function (dotted line) for each of the range data of the 9th, 10th, 12th, 15th, and 19th range bins with the object detection frequency greater than or equal to the threshold frequency of 6 among the 9th to 19th range bins included in the candidate area.

The kernel density estimator 430 may determine the accumulated probability density (KDE) by accumulating kernel functions (dotted lines) of the 9th, 10th, 12th, 15th, and 19th range data. The accumulated probability density may be represented as a solid line in FIG. 7b.

The accumulated probability density shown in FIG. 7B may be created by accumulating five kernel functions, and may have the maximum probability value in the 10th range bin.

The target determiner 440 may determine a range with the maximum accumulated probability density among one or more ranges with the accumulated probability density greater than a specific threshold probability density as a target range.

In the example of FIG. 7B, if the threshold probability density value is expressed as Pth, the range bins with accumulated probability values exceeding Pth are the 9th and 10th range bins.

In this case, the target determiner 440 may determine the 10th range, which is the range with the maximum accumulated probability density, as the target range.

In addition, the target determiner 440 may determine a stationary object detected in the 10th range, which is the target range, as a final stationary target.

That is, as shown in FIG. 8, a stationary object included in the 10th range bin within the candidate area CA may be determined as the final stationary target.

In addition, a stationary object included in the remaining range bins within the candidate area and/or a stationary object included outside the candidate area may be determined as a clutter.

The target determiner 440 may provide or transmit information about the stationary target to an adaptive cruise control (ACC) module or a smart cruise control (SCC) module for following a preceding vehicle in front included in the host vehicle.

The ACC module or SCC module may control the host vehicle to follow the final stationary target corresponding to the transmitted information.

Therefore, it is possible to accurately distinguish the front target even in an environment with clutters hindering target detection, such as a steel tunnel, thereby normally performing the function of following the preceding vehicle.

FIG. 9 illustrates a principle of obtaining distance-velocity information of an object by a signal processor in a radar device according to the present embodiment.

Referring to FIG. 9, the radar device according to the present embodiment may perform a first Fourier transform (FFT) on a fast time of a reception signal to obtain a time component according to a range. In addition, the radar device may perform a second Fourier transform on a slow time thereof to compress a signal present at each range according to a velocity, thereby determining range-velocity information of a target.

More specifically, as shown at the left side of FIG. 9, a signal processor 300 may perform the first Fourier transform 1st FFT, which is an FFT, on a radar reception signal including a fast ramp or a fast chirp, thereby determining a range-time graph which corresponds to a time component according to a range.

Next, the signal processor 300 may perform the second Fourier transform, which is a secondary Fourier transform, on a range-to-time component to determine range-velocity domain information indicating velocity information according to a range as shown at the right side of FIG. 9. The range-velocity domain information may be expressed on a range-Doppler map.

For example, as shown in FIG. 9, if a two-dimensional (2D) Fourier transform (FFT) is performed on a composite signal of the reception signal and a transmission signal, three grid areas may be represented as targets on the range-Doppler map, and the distance and speed of the target may be estimated therefrom.

In addition, the signal processor 300 of the radar device according to the present embodiment may perform Fourier transform on the reception signal and extract the peaks of the reception signal using a constant false alarm rate (CFAR) algorithm or a local maximization method.

In addition, the signal processor 300 may generate a virtual channel vector for the reception signals, and may estimate angular information such as an azimuth angle and an elevation angle of the target using the generated virtual channel vector.

In this case, the signal processor may compensate for a phase error existing between signals corresponding to the first and second transmission antennas. This may be referred to a phase compensation.

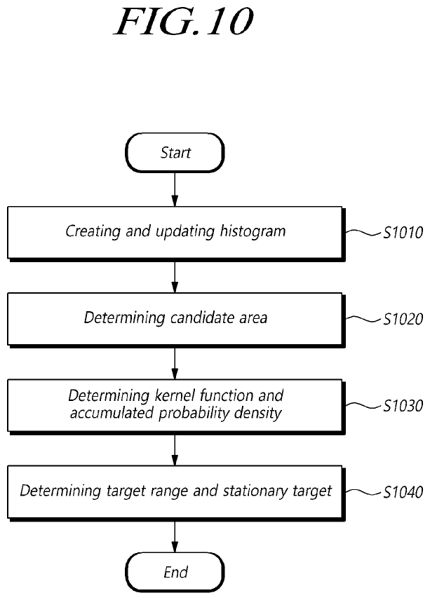

FIG. 10 is a flowchart of a target detection method according to an embodiment of the present disclosure.

The target detection method according to an embodiment of the present disclosure may include a histogram creation and update step (S1010), a candidate area determination step (S1020), an accumulated probability density determination step (S1030), and a target determination step (S1040).

In step S1010, the target detection device may create and update a histogram indicating the object detection frequency for each range using a radar reception signal in response to the movement of the host vehicle.

In this case, the target detection device may update the histogram by accumulating or clustering the object detection frequencies for stationary objects within a driving path of the host vehicle at a plurality of time points.

In step S1020, the target detection device may determine a candidate area within a specific distance range based on the histogram.

In this case, the candidate area may be an area including at least one range bin whose object detection frequency is greater than or equal to a threshold frequency.

In step S1030, the target detection device may create a kernel function for each of a plurality of range data included in the candidate area and determine an accumulated probability density by accumulating the plurality of kernel functions.

Here, the kernel function for each range data may be a normal distribution function with the maximum probability value at a center or a zero position.

In step S1040, the target detection device may determine a target range having an accumulated probability density greater than or equal to the threshold probability density, and determine an object included in the target range as the final stationary target.

In this case, the target range may be a range with the maximum accumulated probability density among one or more ranges with a accumulated probability density greater than a specific threshold probability density.

In addition, in step S1040, the target detection device may determine that an object included in the range having a accumulated probability density less than or equal to the threshold probability density is a clutter.

In addition, although not shown, the target detection method according to one embodiment may further include providing information about a final stationary target to a driver assistance system module for following a preceding vehicle in front included in the host vehicle.

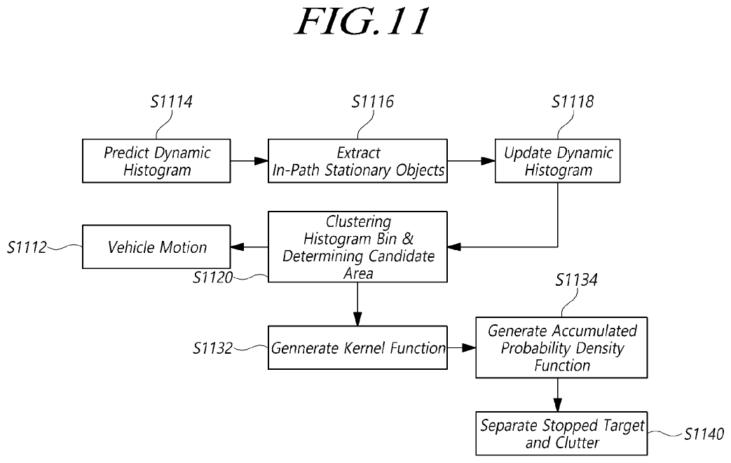

FIG. 11 illustrates a detailed flowchart of a target detection method according to an embodiment.

Referring to FIG. 11, the target detection method according to one embodiment may include estimating a dynamic histogram in an environment in which a host vehicle is moving (S1112, S1114)

The dynamic histogram may be information representing an object detected at a specific time point by range section (i.e., range bin).

The target detection device may determine a driving path P of the host vehicle and extract stationary objects within the driving path. (S1116)

Next, the target detection device may update the dynamic histogram to correspond to a different time point or a view point. (S1118)

The target detection device may determine a candidate area by accumulating or clustering the histogram for each range bin. (S1120)

That is, the target detection device may cluster histograms at a plurality of time points or view points, and determine a candidate area including the range bin with the maximum object detection frequency.

In addition, the target detection device may create a kernel function for each of a plurality of range data included in the candidate area. (S1132)

In addition, the target detection device may determine an accumulated probability density function by accumulating a plurality of created kernel functions. (S1134)

The target detection device may distinguish between a clutter and a stationary target using the determined accumulated probability density function. (S1140)

Specifically, the target detection device may determine a target range having an accumulated probability density greater than or equal to a threshold probability density, and determine an object included in the target range as the final stationary target.

In addition, the target detection device may determine that an object included in a range having an accumulated probability density less than or equal to the threshold probability density is clutter.

The target detection device may provide or transmit information about the final stationary target to a driver assistance system (DAS) module for following a preceding vehicle ahead included in the host vehicle.

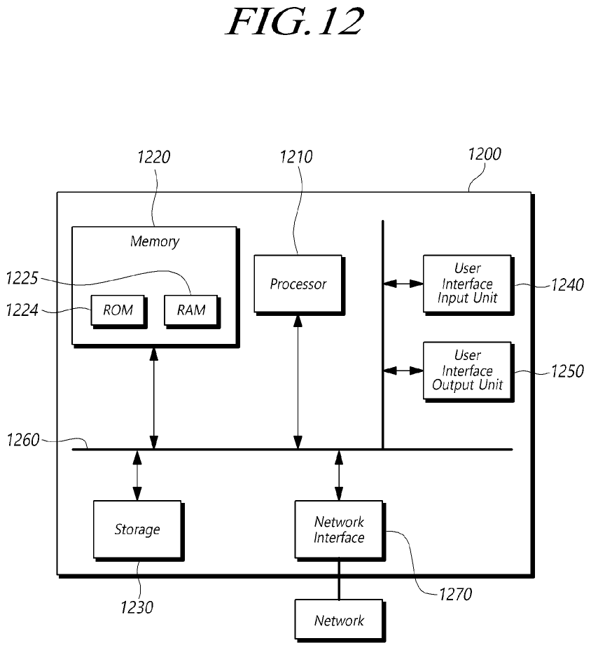

FIG. 12 illustrates an example of the hardware configuration of the transceiver, signal processor, and target detection device included in a radar device according to an embodiment of the present disclosure.

Referring to FIG. 12, the radar device and the target detection device included therein according to the above-described embodiments may be implemented with hardware or software implemented in a computer system.

That is, the transceiver 200, the signal processor 300 and the target detection device 400 of the above-described radar device may be implemented as a computer device having hardware as shown in FIG. 12.

As shown in FIG. 12, a computer system 1200, which is an implementation form of the radar device according to the present embodiment or the transceiver 200, the signal processor 300 and the target detection device included therein, may include one or more elements of one or more processors 1210, a memory 1220, a storage 1230, a user interface input unit 1240, and a user interface output unit 1250, and the elements may communicate with each other through a bus 1260.

In addition, the computer system 1200 may also include a network interface 1270 for connecting to a network. The processor 1210 may be a central processing unit (CPU) or a semiconductor device that executes processing instructions stored in the memory 1220 and/or the storage 1230. The memory 1220 and the storage 1330 may include various types of volatile/nonvolatile storage media. For example, the memory may include a read-only memory (ROM) 1224 and a random access memory (RAM) 1225.

In addition, a software module performing a function of a histogram processor 410, a candidate area determine 420, a kernel density estimator 430, and a target determiner 440 in the target detection device according to an embodiment may be installed in the computer system 1200 used in the present embodiment.

Specifically, in the computer system 1200, there may be installed a software module for creating and updating a histogram representing the object detection frequency for each range, a software module for determining a candidate area, a software module for creating/accumulates a kernel function for each range data to determine an accumulated probability density, and a software module for determining a target range and a final stationary target based on the accumulated probability density.

The processor (main control unit (MCU) 1210 of the radar device according to the present embodiment may execute the above-described software modules stored in the storage 1230 or the memory 1220 to perform a corresponding function.

According to the target detection device and the radar device including the same of the present embodiments, it is possible to precisely distinguish a clutter and a front stationary target by using a candidate area selection and kernel density estimation for each range data in an environment with a clutter hindering the target detection.

Therefore, it is possible to accurately distinguish the front target even in an environment with clutters hindering target detection, such as a steel tunnel, thereby normally performing the function of following the preceding vehicle.

It should be noted that although all or some of the configurations or elements included in one or more of the embodiments described above have been combined to constitute a single configuration or component or operated in combination, the present disclosure is not necessarily limited thereto. That is, within the scope of the object or spirit of the present disclosure, all or some of the configurations or elements included in the one or more of the embodiments may be combined to constitute one or more configurations or components or operated in such combined configuration(s) or component(s). Further, each of the configurations or elements included in one or more of the embodiments may be implemented by an independent hardware configuration; however, some or all of the configurations or elements may be selectively combined and implemented by one or more computer program(s) having one or more program module(s) that perform some or all functions from one or more combined hardware configuration(s). Codes or code segments constituting the computer program(s) may be easily produced by those skilled in the art. As the computer programs stored in computer-readable media are read and executed by a computer, embodiments of the present disclosure can be implemented. The media for storing computer programs may include, for example, a magnetic storing medium, an optical recording medium, and a carrier wave medium.

Further, unless otherwise specified herein, terms ‘include’, ‘comprise’, ‘constitute’, ‘have’, and the like described herein mean that one or more other configurations or elements may be further included in a corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A target detection device comprising:
a histogram processor configured to create and update a histogram representing an object detection frequency for each range using radar reception signals in response to a movement of a host vehicle;
a candidate area determiner configured to determine a candidate area within a specific distance range based on the histogram;
a kernel density estimator configured to create a kernel function for each of a plurality of range data included in the candidate area and determine an accumulated probability density by accumulating a plurality of kernel functions; and
a target determiner configured to determine a target range having an accumulated probability density equal to or greater than a threshold probability density, and determine an object included in the target range as a stationary target.

2. The target detection device of claim 1, wherein the histogram processor updates the histogram by accumulating or clustering object detection frequencies for stationary objects within a driving path of the host vehicle at a plurality of time points.

3. The target detection device of claim 2, wherein the candidate area determiner determines an area including at least one range bin having an object detection frequency greater than or equal to a threshold frequency as the candidate area.

4. The target detection device of claim 1, wherein the target determiner determines a range with the maximum accumulated probability density among one or more ranges with the accumulated probability density equal to or greater than the threshold probability density as the target range.

5. The target detection device of claim 1, wherein the target determiner determines an object included in a range having the accumulated probability density less than or equal to the threshold probability density as a clutter.

6. The target detection device of claim 1, wherein the target determiner provides information about the stationary target to a driver assistance system module for following a preceding vehicle included in the host vehicle.

7. A target detection method comprising:
creating and updating a histogram representing an object detection frequency for each range using radar reception signals in response to a movement of a host vehicle;
determining a candidate area within a specific distance range based on the histogram;
creating a kernel function for each of a plurality of range data included in the candidate area, and determining an accumulated probability density by accumulating a plurality of kernel functions; and
determining a target range having an accumulated probability density equal to or greater than a threshold probability density, and determining an object included in the target range as a stationary target.

8. The target detection method of claim 7, wherein creating and updating a histogram comprises updating the histogram by accumulating or clustering object detection frequencies for stationary objects within a driving path of the host vehicle at a plurality of time points.

9. The target detection method of claim 8, wherein determining a candidate area comprises determining an area including at least one range bin having an object detection frequency greater than or equal to a threshold frequency as the candidate area.

10. The target detection method of claim 7, wherein determining a target range comprises determining a range with the maximum accumulated probability density among one or more ranges with the accumulated probability density equal to or greater than the threshold probability density as the target range.

11. The target detection method of claim 7, wherein determining an object comprises determining an object included in a range having the accumulated probability density less than or equal to the threshold probability density as a clutter.

12. The target detection method of claim 7, further comprising providing information about the stationary target to a driver assistance system module for following a preceding vehicle included in the host vehicle.

13. A radar device comprising:
an antenna unit including at least one transmission antenna and at least one receiving antenna;
a transceiver configured to control to transmit a transmission signal through the antenna unit and receive a reception signal reflected from an object;
a signal processor configured to process the transmission signal and the reception signal to acquire target information; and
a target detection device configured to determine a candidate area within a specific distance range from a host vehicle, create a kernel function for each of a plurality of range data included in the candidate area, determine an accumulated probability density by accumulating a plurality of kernel functions, and determines a stationary target based on the accumulated probability density.

14. The radar device of claim 13, wherein the target detection device comprises:
a histogram processor configured to create and update a histogram representing an object detection frequency for each range using the reception signal in response to a movement of the host vehicle;
a candidate area determiner configured to determine the candidate area based on the histogram;
a kernel density estimator configured to create the kernel function for each of the plurality of range data included in the candidate area and determine the accumulated probability density by accumulating a plurality of kernel functions; and
a target determiner configured to determine a target range having an accumulated probability density equal to or greater than a threshold probability density, and determine an object included in the target range as the stationary target.

15. The radar device of claim 14, wherein the histogram processor updates the histogram by accumulating or clustering object detection frequencies for stationary objects within a driving path of the host vehicle at a plurality of time points.

16. The radar device of claim 15, wherein the candidate area determiner determines an area including at least one range bin having an object detection frequency greater than or equal to a threshold frequency as the candidate area.

17. The radar device of claim 14, wherein the target determiner determines a range with the maximum accumulated probability density among one or more ranges with the accumulated probability density equal to or greater than the threshold probability density as the target range.

18. The radar device of claim 14, wherein the target determiner determines an object included in a range having the accumulated probability density less than or equal to the threshold probability density as a clutter.

19. The radar device of claim 14, wherein the target determiner provides information about the stationary target to a driver assistance system module for following a preceding vehicle included in the host vehicle.
